(19) United States
(12) Patent Application Publication
(10) Pub. No.: US 2007/0124923 A1
(43) Pub. Date: Jun. 7, 2007

(54) Rotatable clamp for wire harness and unit utilizing same

(75) Inventor: Naoto Kogure, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/546,254

(22) Filed: Oct. 12, 2006

(30) Foreign Application Priority Data
Dec. 2, 2005 (JP) 2005-348798

(51) Int. Cl. H01R 43/00; B23P 19/00

(52) U.S. Cl. 29/749; 29/748; 29/761; 29/868

(57) ABSTRACT

The present invention is to prevent an interference between a wire harness and a member disposed in the vicinity of the wire harness, and improve an endurance of the wire harness and stability of an electric power supply. A rotatable clamp for a wire harness includes an inner clamp for holding the wire harness and an outer clamp rotatably supporting the inner clamp, wherein the inner clamp is rotatable in one direction and is regulated to rotate in another direction orthogonal to the one direction. A unit utilizing the rotatable clamp has the wire harness swingably arranged between a sliding structure and the rotatable clamp disposed on a main body, wherein the wire harness is allowed to swing in the one direction so as to prevent the wire harness from interfering with a member disposed in the another direction. A minor axis and major axis of a protection tube with a flat shape for the wire harness correspond with the one direction and the another direction, respectively.

### BACKGROUND OF THE INVENTION

1. Field of the Invention

The present invention relates to a rotatable clamp for swingably supporting a wire harness to supply electric power from a vehicle body to a sliding door thereof, and a unit utilizing the same.

2. Description of the Related Art

FIGS. 4 and 5 show a conventional power supply apparatus for a sliding door of a motor vehicle and a unit utilizing the same (for example, FIGS. 4 and 7 in JP, 2001-354085, A).

The power supply apparatus 50 includes a synthetic resin protector 42 installed vertically in a sliding door 41, a leaf spring 44 for urging a wire harness 43 to upwardly bend in the protector 42, and a rotatable clamp 51 disposed in a vehicle body 47 supporting rotatably the wire harness 43 in a circumferential direction thereof.

The protector 42 has a base and a cover (not shown). The base has a vertical base plate 52 and an outer wall 53. When the cover is attached to the protector 42 with facing to the base plate 52, an elongated lower opening 45 is formed at a lower end of the protector 42 for leading out the wire harness 43.

One side portion 43a of the wire harness 43 is led out through a front opening 54 of the protector 42 and connected to auxiliary units of the sliding door 41. Another portion 43b of the wire harness 43 is guided through a step space 46 between the sliding door 41 and the vehicle body 47, and supported at the rotatable clamp 51 in the vicinity of a step portion 48. The wire harness 43 is connected to a wire harness, not shown, of the vehicle body 47 at the rotatable clamp 51 for supplying the electric power to the sliding door 41.

FIGS. 4 and 5 show the sliding door 41 fully closed and half opened, respectively. When the sliding door 41 is closed, the wire harness 43 is pulled backwardly with the rotatable clamp 51 against the urging force of the leaf spring 44. When the sliding door 41 is half opened and the protector 42 comes closest to the rotatable clamp 51, the leaf spring 44 urges upwardly the wire harness 43 to avoid drop-down and sandwiching of the wire harness 43 between the sliding door 41 and the vehicle body 47.

When the sliding door 41 is further moved backwardly, the wire harness 43 is forwardly pulled out against the urging force of the leaf spring 44 with the rotatable clamp 51 as a supporting point. When the sliding door 41 is started to open from the fully closed state, the sliding door 41 separates away from a curved guide rail, not shown, of the vehicle body 47.

FIGS. 6 and 7 show a conventional rotatable clamp 51 for a wire harness 43 and a unit utilizing the same disclosed in FIGS. 1 and 2 of JP, 2004-282879, A. The rotatable clamp 51 of FIG. 6 has a horn-shaped harness guide 55 in contrast with that of FIG. 7. The detailed explanation for the portions of FIG. 6 same as those of FIG. 7 is omitted.

The rotatable clamp 51 has an outer clamp 56 with a rectangular tube shape, which is separable above and below and has a separating face 60 as seen in FIG. 6, and an inner clamp 57 with a sphere shape supported rotatably in the outer clamp 56. As shown in FIG. 7, the outer clamp 56 has inner supporting faces 58 with a circular section, which are disposed in an inner wall of the outer clamp 56 and facing to the inner clamp 57, and a wide groove 59 with a circular section disposed between the inner supporting faces 58. The groove 59 is formed around the inner wall of the outer clamp 56.

The inner clamp 57 is separable into two parts in a radial direction of the wire harness 43 and has a pair of projections 62 disposed in an outer wall of the inner clamp 57. The projections 62 movably engage with the groove 59. The backward and forward directions are defined here the inserting direction of the wire harness 43 to the rotatable clamp 51.

The inner clamp 57 has ribs 67 to be engaged with grooves 65 of a corrugated tube 64, which is made of a synthetic resin and protects the wire harness 43, at an inner wall of a harness insertion hole 63. The corrugated tube 64 has the grooves 65 and ridges 66, which are disposed in a circumference direction of the tube and arranged along a longitudinal direction thereof, and has a good flexibility. As shown in FIG. 6, the corrugated tube 64 terminates at the rotatable clamp 51 and an end portion of the corrugated tube 64 is supported with the inner clamp 57 and a plurality of covered electric wires 68 are led out to the motor vehicle body from the inner clamp 57.

As shown in FIG. 7, the wire harness 43 is guided out of the elongated lower opening 45 of the protector 42 having a base 69 and a cover 70, and supported with the inner clamp 57. The inner clamp 57 is rotatably supported with the outer clamp 56. The outer clamp 56 is fixed to the vehicle body 47 with a bracket 71 as shown in FIG. 6.

When the sliding door 41 is closed or opened as in FIGS. 4 and 5, the wire harness 43 swings backwardly and forwardly between the sliding door 41 and the vehicle body 47 and the inner clamp 57 rotates integrally with the wire harness 43 in the circumferential direction of the wire harness 43 so that twisting of the wire harness 43 is prevented.

In the conventional rotatable clamp 51 and the unit utilizing the same 51, when members such as a weather strip 72, a part, or a structure are disposed in the vicinity of the inner clamp 57, the member 72 may interfere with the corrugated tube 64 and damage the corrugated tube 64.

### SUMMARY OF THE INVENTION

An object of the present invention is to provide a rotatable clamp for a wire harness and a unit utilizing the same to prevent an interference between a wire harness and a member disposed in the vicinity of the wire harness, and improve an endurance of the wire harness and stability of an electric power supply.

According to a first object of the present invention, a rotatable clamp for a wire harness includes an inner clamp for holding the wire harness and an outer clamp rotatably supporting the inner clamp, wherein the inner clamp is rotatable in one direction and is regulated to rotate in another direction orthogonal to the one direction.

Preferably, the outer clamp rotatably supports the inner clamp with engagement of a pair of projections and a pair of recesses.

Preferably, a gap is formed between the pair of projections and the pair of recesses so as that the inner clamp is a little rotatable in the another direction.

According to a second aspect of the present invention, a unit utilizing the rotatable clamp has the wire harness swingably arranged between a sliding structure and the rotatable clamp disposed on a main body, wherein the wire harness is allowed to swing in the one direction so as to prevent the wire harness from interfering with a member disposed in the another direction.

Preferably, a minor axis and major axis of a protection tube with a flat shape for the wire harness correspond with the one direction and the another direction, respectively.

### BRIEF DESCRIPTION OF THE DRAWINGS

FIG. 1 is a vertical sectional view showing an embodiment of a rotatable clamp for a wire harness and a unit utilizing the same of the present invention;

FIG. 2A is a front view showing an inner clamp holding a protection tube with an oval shaped section;

FIG. 2B is a vertical sectional view showing a rotatable clamp holding the inserted protection tube with the oval shaped section;

FIG. 3A is a front view of the inner clamp rotated with 90 degrees from FIG. 2A;

FIG. 3B is a horizontal sectional view of the rotatable clamp rotated with 90 degrees from FIG. 2B;

FIG. 3C is a horizontal sectional view showing a wire harness swung to the right and left;

FIG. 4 is a perspective view showing an embodiment of an arrangement of a wire harness of a conventional power supply apparatus of a sliding door when the sliding door is closed;

FIG. 5 is a perspective view showing the arrangement of the wire harness when the sliding door is opened;

FIG. 6 is an essential perspective view showing the arrangement of the wire harness utilizing the conventional rotatable clamp; and

FIG. 7 is a vertical sectional view showing the arrangement of the wire harness utilizing the conventional rotatable clamp.

### DETAILED DESCRIPTION OF THE PREFERRED EMBODIMENTS

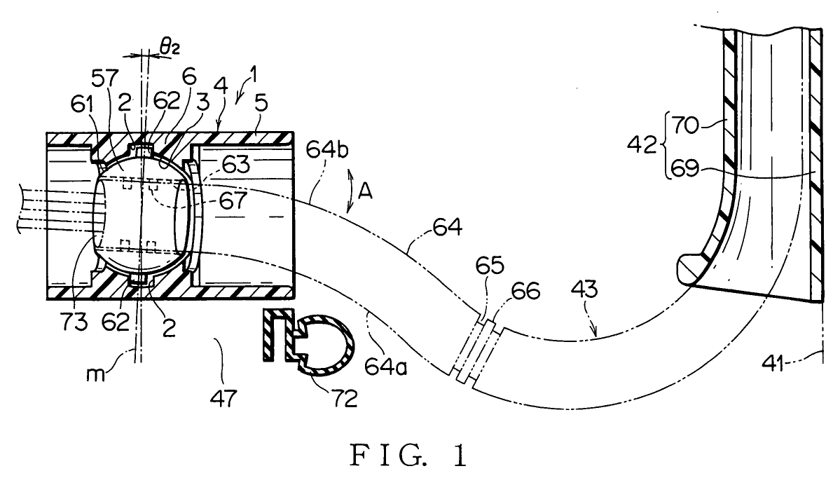

FIGS. 1-3 show an embodiment of a rotatable clamp for a wire harness and an embodiment of a unit utilizing the same according to the present invention. The reference signs of the present invention same as the conventional clamp and unit are not explained in detail.

As shown in FIG. 1, a wire harness 43 is connected between a protector 42 disposed in a sliding door 41 and a rotatable clamp 1 disposed in a vehicle body 47, which has a weather strip 72 for waterproof in the vicinity of the rotatable clamp 1, similar to the conventional rotatable clamp and unit.

The rotatable clamp 1 is made of a synthetic resin and has an inner clamp 57 and an outer clamp 4. The inner clamp 57 is ball-shaped and has a pair of cylindrical projections (axles or protrusions) 62, hereinafter projections, at an outer wall 61 thereof. The outer clamp 4 has a pair of bores (recesses) 2 with a circular section at an inner wall 3 thereof. The pair of projections 62 engage the inner clamp 57 with the outer clamp 4 with a very small angle θ of swing.

The inner clamp 57 is vertically separable. The inner clamp 57 has coaxially a circular or oval-shaped (flat-shaped) insertion hole 63, which has ribs 67 (projections) at an inner wall of the insertion hole 63 for engaging with grooves 65 of a corrugated tube 64 of the wire harness 43.

Front and rear ends of the inner clamp 57 are cut out in planes. In order to support the corrugated tube 64 with the inner clamp 57, the inner clamp 57 is firstly separated into an upper and lower parts and the grooves 65 of the corrugated tube 64 are engaged with the ribs 67 of the inner clamp 57. Then, the upper and lower parts are engaged together with a locking means such as locking claw and locking groove so as to support the wire harness 43 in the inner clamp 57.

The pair of the projections (axles) 62 are disposed at the outer wall 61 of the inner clamp 57 opposed to each other with respect to the center of the inner clamp 57. It is preferable to resin-mold the projections 62 integrally with the inner clamp 57.

The outer clamp 4 has an outer wall 5 with a rectangular tube shape and a thick holding wall 6, which is integrally disposed at an inner wall of the outer clamp 4 and at the center of the longitudinal direction of the outer wall 5. A long inner wall of the holding wall 6 has a circular section and extends along the backward and forward directions of the rotatable clamp 1. The long inner wall acts as the inner supporting face 3 for the inner clamp 57. An inner diameter of the supporting face 3 is a little larger than the outer diameter of the inner clamp 57.

The inner supporting face 3 has the pair of bores 2 at the centers of an upper and lower walls of the holding wall 6. An inner diameter of the bores 2 is a little larger than an outer diameter of the projections 62 of the inner clamp 57. The pair of projections 62 are aligned with an axis line m. The inner clamp 57 is rotatable (swingable) to the right and left (the forward and backward directions of the vehicle body) with facing to the inner supporting face 3. The inner clamp 57 rotates (swings) by a very small angle of θ₂ along the inner supporting face 3 so as that the corrugated tube 64 moves vertically with a small amount compared to the conventional unit.

The angle θ₂ can be adjusted by changing the difference between the outer diameter of the projections 62 and the inner diameter of the bores 2 to regulate the rotation of the inner clamp 57. The adjustment, however, is limited to the angle with which a lower face 64a of the corrugated tube 64 does not interfere with the member, or the weather strip 72 in the embodiment, disposed in the lower vicinity of the rotatable clamp 1.

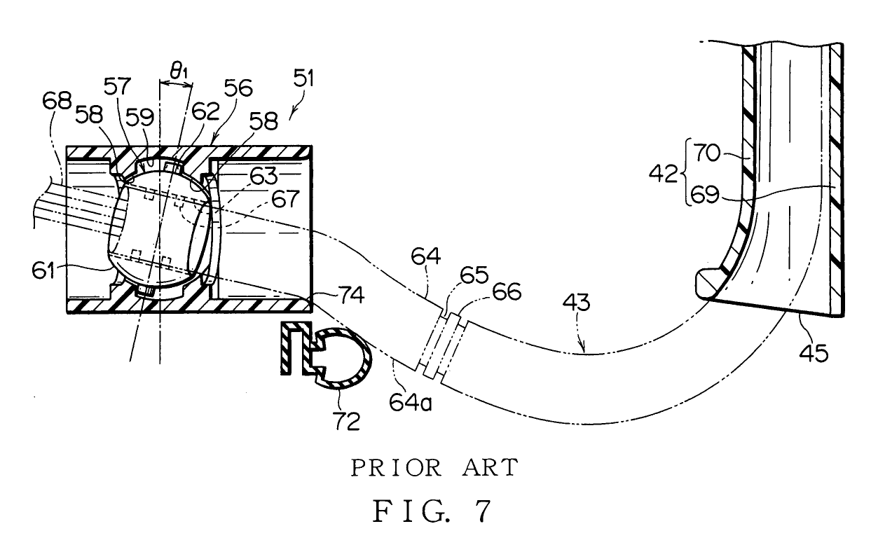

In the conventional rotatable clamp 51 shown in FIG. 7, the lower face 64a of the corrugated tube 64 contacts with an inner edge 74 of an opening of the outer clamp 56. However, the setting of the small angle θ₂ prevents the outer clamp 4 from interfering with the corrugated tube 64 and also a sliding wear of the corrugated tube 64. It is also possible to completely eliminate the vertical movement of the inner clamp 57, or the corrugated tube 64, by adjusting the difference of the diameters of the projections 62 and bores 2.

When the sliding door 41 is closed or opened and the protector 42 is moved backwardly and forwardly with the sliding door 41, the wire harness 43, or the corrugated tube 64, swings in the forward and rearward directions of the vehicle and the inner clamp 57 also simultaneously rotates about the axis line m of the pair of projections 62.

When the sliding door 41 is fully closed or fully opened from half opened state, the wire harness 43 is pulled to the back-and forth direction of the vehicle and the inner clamp 57 rotates a little upwardly in an arrow A to absorb the tension. When the sliding door 41 is half opened and the wire harness 43 is slacked, the inner clamp 57 rotates a little downwardly in the arrow A to form a bending portion 64b close to the rotatable clamp 1 with a large radius. The rotation of the inner clamp 57 in the direction of the arrow A is achieved with the difference of the diameters between the projections 62 and bores 2. The small rotation of the inner clamp 57 keeps endurance of the wire harness 43 more than without the movement.

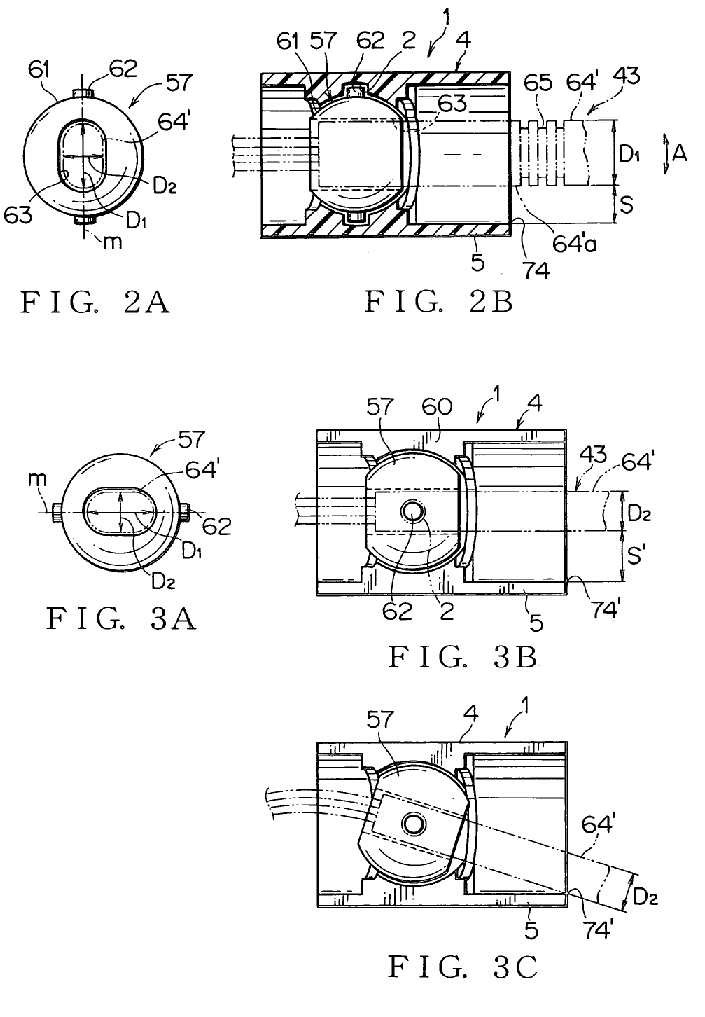

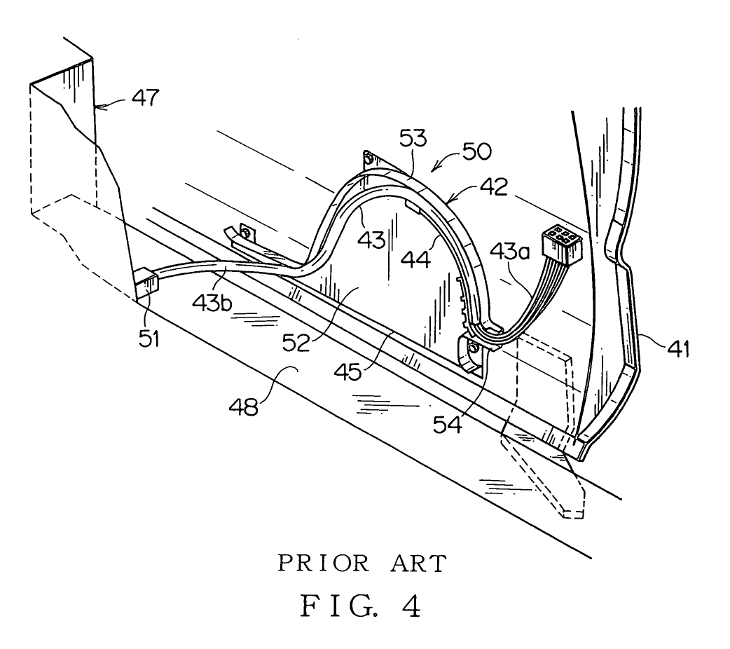

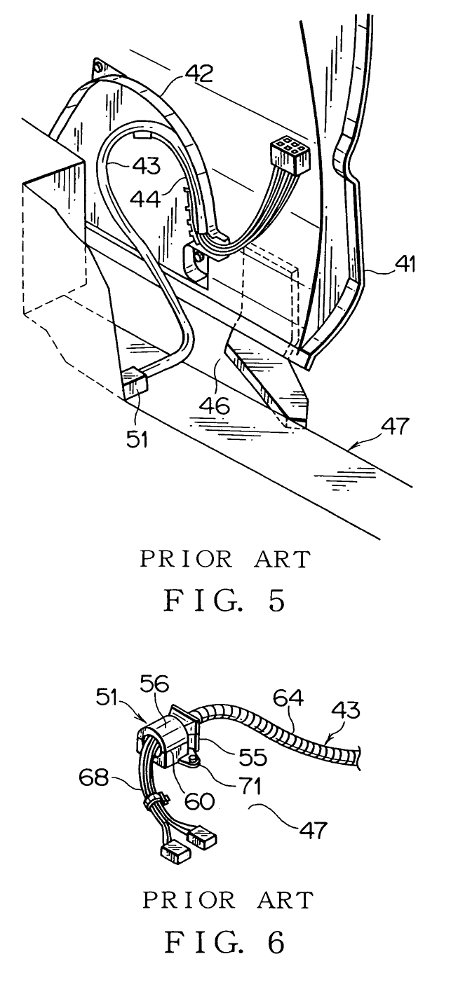

The rotatable clamp 1 of FIG. 1 is utilized for the corrugated tube 64 having both the circle and oval shaped (flat-shaped) sections. FIGS. 2A-2B and 3A-3C show a rotatable clamp 1 utilized for a corrugated tube 64′ having the oval shaped section. The same parts of FIGS. 2A-2B and 3A-3C as those of FIG. 1 are not explained in detail.

As shown in FIGS. 2A-2B, an inner clamp 57 of the rotatable clamp 1 holds the corrugated tube 64′ with the major axis D1 being vertical and along the direction of the axis line m of the pair of projections 62.

The inner clamp 57 has an insertion hole 63 with an oval section and disposed concentrically with an outer wall, or sphere, 61. The insertion hole 63 has ribs, not shown, in an inner wall thereof and the ribs engage with grooves 65 of the corrugated tube 64′.

When the inner clamp 57 holds a wire harness 43, a large gap S is formed between an lower face 64′a of the corrugated tube 64′ and a lower end 74 of an opening of the outer clamp 4. Pair of projections 62 of the inner clamp 57 are held with the outer clamp 4 so that the inner clamp 57 hardly rotates in a direction of an arrow A about the projections 62 and the gap S is kept. Thus, the large gap S prevents the corrugated tube 64′ from interfering with a member disposed close to the lower end 74 of the opening.

The corrugated tube 64′ of FIG. 2 has also a bending portion, not shown, same as in FIG. 1 when extended to a sliding door. In the case of the oval shaped (flat shaped) section, the corrugated tube 64′ hardly bends in a direction of the major axis D1. As shown in FIG. 2A, the major axis D1 of the corrugated tube 64′ is vertical so that a bending diameter is significantly regulated and a slack of the corrugated tube 64′ is minimized.

As shown in FIGS. 3A-3B, a minor axis D2 of the corrugated tube 64′ is orthogonal to the axis line m of the pair of projections 62. A large gap S′ is formed between side faces of the corrugated tube 64′ and side ends 74′ of the opening of the outer clamp 4. When the outer wall 5 of the outer clamp 4 is tube-shaped and has a square section, the gap S′ of FIG. 3B is larger than the gap S of FIG. 2B to the difference between the major axis D1 and minor axis D2.

As shown in FIG. 3C, the large gap S′ prevents the corrugated tube 64′ from strongly interfering with the side ends 74′ of the opening when the sliding door is closed and opened. Accordingly, the corrugated tube 64′ has an improved endurance.

In the embodiment, the outer clamp 4 has the straight outer wall 5. The outer wall 5 may have a horn-shaped guide wall as shown in FIG. 6 of the conventional type.

In the embodiment, the inner clamp 57 has the spherical outer wall 61. The inner clamp 57 may have a rugby ball shape with a pair of projections disposed along the major axis, and have a rectangular shape with a pair of projections 62, or axles, disposed at an upper and lower surfaces. In the case of the rectangular shape, the inner clamp 57 is supported with the outer clamp having a large size and rotatable in the horizontal direction.

In the embodiment, the pair of projections 62 are disposed on the inner clamp 57 and the bores 2 engaged with the projections 62 are disposed on the outer clamp 4. The pair of projections 62 can be disposed on the inner wall of the outer clamp 4 and the bores 2 can be disposed on the outer wall 61 of the inner clamp 57. The inner clamp 57 may have the projection 62 and bore 2 and the outer clamp 4 has the bore 2 and projection 62 corresponding to the inner clamp 57. In the embodiment, the bores 2 are formed on the inner wall of the outer clamp 4. Through-holes can be formed on the outer clamp 4.

In the embodiment, the corrugated tube 64 is utilized for protecting the wire harness 43 arranged between the vehicle body 47 and the sliding door 41. A net tube made of a synthetic resin or a flat surface tube made of vinyl or urethane can be utilized in place of the corrugated tube 64. In this case, a sharp projection is pierced into the protection tube for fixing or the protection tube is fixed to the inner clamp 57 with adhesion.

In the embodiment, the rotatable clamp 1 is adapted to the power supply apparatus 50 having the protector 42 and the leaf spring 44 urging upwardly the wire harness 43. The wire harness can be arranged in a loop or reel manner in a curved or rectangular shaped protector. The wire harness can be held vertically and swung like a pendulum. Other resilient members such as helical spring or coil spring can be utilized in place of the leaf spring 44. A repulsive force against bending of the wire harness can be utilized in place of the resilient members.

In the embodiment, the protector 42 is disposed vertically. The protector with a lower height can be disposed inside the sliding door. The protector can be disposed horizontally on the vehicle body in place of the sliding door 41. The rotatable clamp 1 can be disposed in the sliding door in place of the vehicle body. The wire harness 43 can be arranged directly in the sliding door without the protector 42.

The rotatable clamp 1 and the unit utilizing the same can be adapted to a sliding door of a vehicle other than the motor vehicle and a sliding door of a machine tool or testing machine other than the vehicle for supplying electric power to the main body of the vehicle body, and the tool or machine. The present invention is adapted to a sliding structure such as the sliding door and a main body such as the vehicle body.

What is claimed is:

1. A rotatable clamp for a wire harness comprising:
an inner clamp for holding the wire harness; and
an outer clamp rotatably supporting the inner clamp,
wherein said inner clamp is rotatable in one direction and is regulated to rotate in another direction orthogonal to the one direction.

2. The rotatable clamp as claimed in claim 1, wherein said outer clamp rotatably supports the inner clamp with engagement of a pair of projections and a pair of recesses.

3. The rotatable clamp as claimed in claim 2, wherein a gap is formed between the pair of projections and the pair of recesses so as that the inner clamp is a little rotatable in the another direction.

4. A unit utilizing said rotatable clamp as claimed in claim 1, said unit having the wire harness swingably arranged between a sliding structure and the rotatable clamp disposed on a main body, wherein said wire harness is allowed to swing in the one direction so as to prevent the wire harness from interfering with a member disposed in the another direction.

5. The unit as claimed in claim 4, wherein a minor axis and major axis of a protection tube with a flat shape for the wire harness correspond with the one direction and the another direction, respectively.
